(19) United States
(12) Patent Application Publication
(10) Pub. No.: US 2007/0261654 A1
(43) Pub. Date: Nov. 15, 2007

(54) SYSTEM AND METHOD FOR REDUCING PRESSURE IN AN INTAKE MANIFOLD OF AN INTERNAL COMBUSTION ENGINE

(75) Inventors: Jonathan Butcher, Kansas City, MO (US); Kenneth Frederick, Dearborn, MI (US); Christopher Lear, Dearborn, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 11/382,754

(22) Filed: May 11, 2006

(51) Int. Cl. F02M 1/00; F02M 35/10

(52) U.S. Cl. 123/179.18; 123/184.53

(57) ABSTRACT

A pressure reducing system and method for an internal combustion engine. The system includes an intake manifold and an evacuation subsystem. The intake manifold is associated with the internal combustion engine. The evacuation subsystem is selectively fluidly coupled to the intake manifold. The evacuation subsystem is operative to reduce pressure in the intake manifold during start-up of the internal combustion engine.

### BACKGROUND OF THE INVENTION

1. Field of the Invention

The invention relates to a system and method for reducing pressure in an intake manifold of an internal combustion engine.

2. Background Art

Presently, conventional vehicles and hybrid vehicles having an internal combustion engine (e.g., gasoline engine, diesel engine and/or the like) generally perform a series of initial compression events (i.e., compression of substantially un-combustible air) followed by a series of initial combustion events (i.e., compression of a combustible air/fuel mixture)during start-up of the internal combustion engine.

Such compression of the substantially un-combustible air during the initial compression events may generate undesirable noise, vibration and/or harshness. The noise, vibration and/or harshness may be particularly severe in a hybrid vehicle due to the high speed at which the internal combustion engine is spun during start-up of the engine, also known as spin-up in the context of a hybrid vehicle.

In addition to generating undesirable noise, vibration and/or harshness, the un-combusted air may oxygen load the exhaust catalyst of a corresponding exhaust system as the un-combusted air is expelled from the vehicle. Such oxygen loading of the exhaust catalyst generally reduces the conversion capabilities of the catalyst during the subsequent combustion events.

Similarly, conventional internal combustion engines may emit an undesirable amount of Hydrocarbons during the initial combustion events due to the low temperature, and therefore low conversion capabilities, of the exhaust catalyst.

It would be desirable, therefore, to have a system and method for reducing pressure in an intake manifold of an internal combustion engine such that undesirable noise, vibration, harshness and/or emissions may be reduced during start-up of a the internal combustion engine in a conventional and/or hybrid vehicle.

### SUMMARY OF THE INVENTION

In at least one embodiment of the present invention, noise, vibration and/or harshness generated by the compression of un-combusted air during start-up/spin-up of an internal combustion engine may be reduced by evacuating the un-combustible air from the intake manifold of the engine such that pressure is reduced in the intake manifold during start-up/spin-up of the engine.

In at least one other embodiment of the present invention, Hydrocarbon emissions emitted during initial start-up of an internal combustion engine may be reduced by evacuating air from the intake manifold such that pressure is reduced in the intake manifold during start-up of the engine. In general, evacuating air from the intake manifold may reduce oxygen loading of the exhaust catalyst. In addition, such evacuation may reduce the amount of fuel injected during the initial combustion events of start-up. By limiting the amount of fuel injected into the engine during start-up, the resulting level of emissions passing unconverted through the relatively cold emissions system catalyst may be reduced.

According to the present invention, then, a pressure reducing system is provided for an internal combustion engine. The system comprises an intake manifold and an evacuation subsystem. The intake manifold is associated with the internal combustion engine. The evacuation subsystem is selectively fluidly coupled to the intake manifold. The evacuation subsystem is operative to reduce pressure in the intake manifold during start-up of the internal combustion engine.

Also according to the present invention, a method is provided for reducing pressure in an intake manifold of an internal combustion engine. The method comprises opening a reservoir control valve to fluidly couple an evacuation reservoir to the intake manifold when the internal combustion engine is operating and a predetermined condition is satisfied, determining when a subsequent start-up of the internal combustion engine is desired, and opening the reservoir control valve to fluidly couple the evacuation reservoir to the intake manifold during the subsequent start-up of the internal combustion engine.

Still further according to the present invention, a method is provided for reducing pressure in an intake manifold of an internal combustion engine. The method comprises determining when reduction of the pressure in the intake manifold is desired, opening an evacuation control valve to fluidly couple an inlet port of an evacuation pump to the intake manifold when reduction of the pressure in the intake manifold is desired, and energizing the evacuation pump to remove gaseous fluid from the intake manifold such that the pressure in the intake manifold is reduced.

### BRIEF DESCRIPTION OF THE DRAWINGS

FIG. 1 is a schematic diagram illustrating a system for reducing pressure in an internal combustion engine of a vehicle according to an embodiment of the present invention;

FIG. 2 is a schematic diagram of a combustion cylinder coupled to an intake manifold according to an embodiment of the present invention;

FIG. 3 is a schematic diagram of a system having an internal combustion engine coupled to a transmission of a hybrid electric vehicle according to an embodiment of the present invention;

FIG. 4 is a flow diagram of a method for reducing pressure in an intake manifold of an internal combustion engine according to an embodiment of the present invention; and

FIG. 5 is a flow diagram of another method for reducing pressure in an intake manifold of an internal combustion engine according to an embodiment of the present invention.

### DETAILED DESCRIPTION OF THE PREFERRED EMBODIMENT(S)

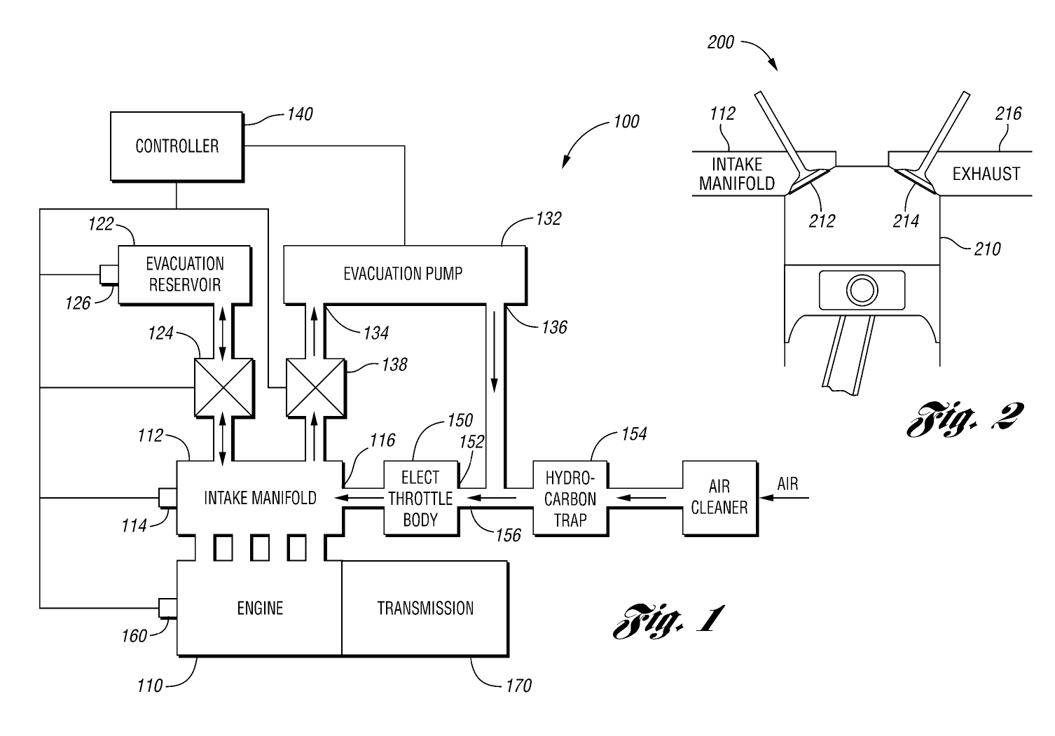

Referring to FIG. 1, a schematic diagram is provided illustrating a system 100 for reducing pressure in an internal combustion engine 110 (e.g., gasoline engine, diesel engine and/or the like) of a vehicle (e.g., automobile). The system 100 generally comprises an intake manifold 112 associated with the internal combustion engine 110 and an evacuation subsystem selectively fluidly coupled to the intake manifold 112. In general, the evacuation subsystem is operative to reduce pressure in the intake manifold 112, and therefore the engine 110, such that pressure is reduced (i.e., at a reduced level) in the intake manifold during start-up/spin-up of the engine 110.

The system 100 may include a controller 140, such as a powertrain control module, for controlling the functionality of one or more components (e.g. 110, 122, 124, 132, 138 and/or the like) of the system 100. In general, the controller 140 may be a computer or other logical device which executes programs and/or which performs other logical exercises. It is contemplated that control of the functionality of the one or more components of the system 100 may be incorporated into a single controller, such as is shown in FIG. 1. Alternatively, control of the functionality may be distributed among a plurality of controllers. In general, controller inputs and outputs may be received and passed between controllers and/or the one or more components via a network, dedicated wires, and/or the like.

In at least one embodiment, the evacuation subsystem may comprise an evacuation reservoir 122 and a reservoir control valve 124 that selectively fluidly couples the evacuation reservoir 122 to the intake manifold 112. As illustrated in FIG. 1, the reservoir control valve 124 may be coupled to the evacuation reservoir 122 and/or to the intake manifold 112 via a pipe (i.e., hose, conduit, etc.). In another embodiment, the reservoir control valve 124 may be integrated with or disposed adjacent to the evacuation reservoir 122 and/or the intake manifold 112 such that no pipe is necessary. In general, the reservoir control valve 124 is in electronic communication with the controller 140 and may be selectively opened and closed such that the evacuation reservoir 122 is selectively fluidly coupled to the intake manifold 112 in response to one or more signals generated by the controller 140.

In general, pressure in the evacuation reservoir 122 may be reduced by opening the reservoir control valve 124 when the engine 110 is operating (i.e., running, on, etc.) and the pressure in the intake manifold, such as the manifold absolute pressure (i.e., MAP), is low in relation to the pressure in the evacuation reservoir 122.

In at least one embodiment, the system 100 may identify low pressure in the intake manifold using a manifold pressure sensor 114 in electronic communication with the controller 110 and configured to generate a manifold pressure signal indicative of the pressure in the intake manifold. Accordingly, the reservoir control valve 124 may be opened when the internal combustion engine 110 is operating and the manifold pressure signal indicates that the pressure in the intake manifold 112 is below a predetermined intake manifold pressure threshold.

Similarly, in at least one embodiment, the system 100 may comprise a reservoir pressure sensor 126 in electronic communication with the controller 140 and configured to generate a reservoir pressure signal indicative of the pressure in the evacuation reservoir 122. In such an embodiment, the predetermined intake manifold pressure threshold may be based at least in part on the reservoir pressure signal.

When the engine 110 is shut-down and/or otherwise de-energized, the reservoir control valve 124 may be closed (i.e., shut) such that the reduced pressure in the evacuation reservoir 122 may be substantially contained (i.e., sealed) within the evacuation reservoir 122. Additionally, or in the alternative, the reservoir control valve 124 may be closed when the reservoir pressure signal indicates that the pressure in the evacuation reservoir 122 is less than a predetermined reservoir pressure threshold. However, it should be understood that the reservoir control valve 124 may be closed in response to any appropriate stimulus (i.e., triggers) to meet the design criteria of a particular application.

In general, the reservoir control valve 124 may be opened during a subsequent start-up of the internal combustion engine 110 such that the pressure in the intake manifold 112 may be reduced by evacuation of fluid (i.e., gasses, air, etc.) from the intake manifold 112 into the evacuation reservoir 122.

In at least one other embodiment, the evacuation subsystem may comprise an evacuation pump 132 having an inlet port 134 and an outlet port 136, and an evacuation control valve 138. In general, the evacuation control valve 138 may be disposed between and fluidly coupled to the intake manifold 112 and the inlet port 134. As illustrated in FIG. 1, the evacuation control valve 138 may be coupled to the inlet port 134 of the evacuation pump 132 and/or to the intake manifold 112 via a pipe (i.e., hose, conduit, etc.). In another embodiment, the evacuation control valve 138 may be integrated with or disposed adjacent to the inlet port 134 and/or to the intake manifold 112 such that no pipe is necessary. In general, the evacuation control valve 138 and/or evacuation pump 132 are in electronic communication with the controller 140. The evacuation control valve 138 may be selectively opened or closed such that the evacuation pump 132 is selectively fluidly coupled to the intake manifold 112 in response to one or more signals (i.e., evacuation control signals) generated (i.e., issued) by the controller 140. Similarly, the evacuation pump 132 may be selectively energized and de-energized in response to one or more signals (i.e., evacuation control signals) from the controller 140.

In general, the one or more evacuation control signals may be selectively generated by the controller 140 when the internal combustion engine 110 is de-activated, which may, in at least one embodiment, include a period of time during start-up of the engine 110 but prior to steady state operation of the engine 110. As previously discussed, one or more embodiments of the system 100 may include the manifold pressure sensor 114 in electronic communication with the controller 140 and configured to generate a manifold pressure signal indicative of a pressure in the intake manifold 112. In such an embodiment, the one or more evacuation control signals may be generated by the controller 140 when the internal combustion engine is de-activated (i.e., de-energized) and the manifold pressure signal indicates that the pressure in the intake manifold 112 is above a predetermined intake manifold pressure limit.

By selectively opening the evacuation control valve 138 and energizing the evacuation pump 132, the pressure in the intake manifold 112, and therefore the engine 110, may be reduced.

The evacuation control valve 138 may be opened and the evacuation pump 112 may be energized using any appropriate sequence to meet the design criteria of a particular application. In one exemplary embodiment, the evacuation control valve 138 may be opened prior to energizing the evacuation pump 132. In another exemplary embodiment, the evacuation control valve 138 may be opened substantially simultaneously with the energizing of the evacuation pump 132. In yet another exemplary embodiment, the evacuation pump 132 may be energized prior to opening the evacuation control valve 138.

Furthermore, selective operation of the evacuation control valve 138 and the evacuation pump 132 may be implemented such that energy, such a electrical energy, is conserved. In one exemplary embodiment, the evacuation control valve 138 may be closed and the evacuation pump 132 de-energized when the a vehicle including the engine 110 is operating in park or neutral gear. In another exemplary embodiment, the evacuation control valve 138 may be closed and the evacuation pump 132 de-energized when an operator of the vehicle applies a vehicle brake for a predetermined period of time. However, any appropriate energy conserving operation may be implemented to meet the design criteria of a particular application.

In general, the evacuation control valve 138 may be closed when the evacuation pump 132 is de-energized to inhibit backflow of gaseous fluids (e.g., air, exhaust, etc.) from the evacuation pump 132 into the intake manifold 112.

As illustrated in FIG. 1, the system 100 may also include an electronic throttle body 150 fluidly coupled to an inlet 116 of the intake manifold 112, and a hydrocarbon trap 154 fluidly coupled to an inlet 152 of the electronic throttle body 150 via a conduit 156. In at least one embodiment, the outlet port 136 of the evacuation pump 132 may be fluidly coupled to the conduit 156 between the electronic throttle body 150 and the hydrocarbon trap 154. In such an embodiment, vehicle emission of Hydrocarbons evacuated from the intake manifold 112 via the evacuation pump 132 may be reduced.

It should be understood that, in at least one other embodiment, the evacuation subsystem may comprise the evacuation reservoir 122, the reservoir control valve 124, the evacuation pump 132, and the evacuation control valve 138. That is, the evacuation reservoir 122 based evacuation subsystem and the evacuation pump 132 based evacuation subsystem are not mutually exclusive and both may be implemented in the system 100 to reduce pressure in an internal combustion engine 110 having an intake manifold 112.

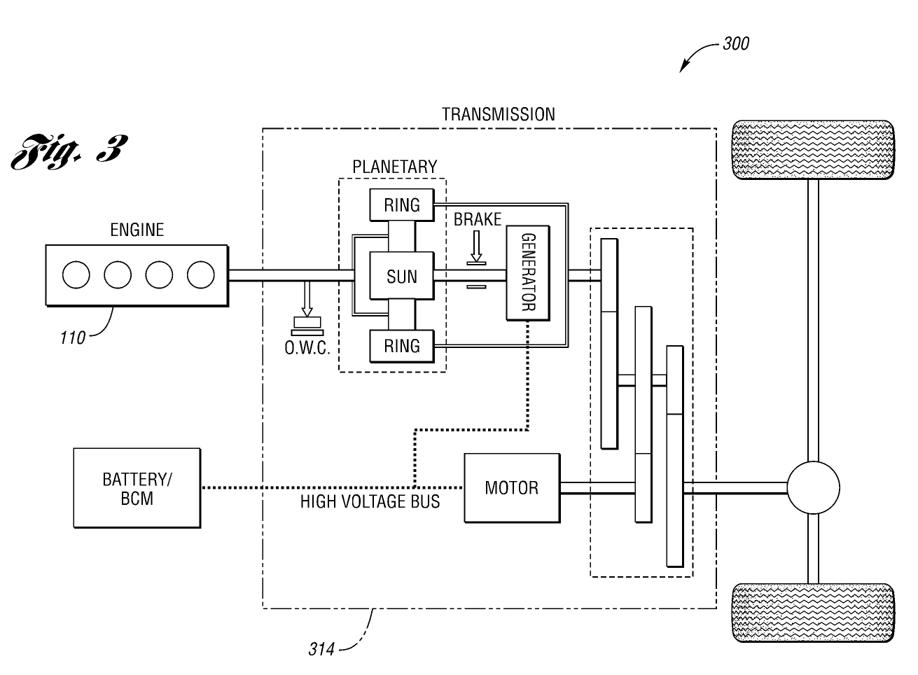

Referring to FIG. 2, a schematic diagram 200 of a combustion cylinder 210 coupled to the intake manifold 112 is provided. As illustrated, each combustion cylinder of a vehicle may include an intake valve 212 disposed between the intake manifold 112 and the cylinder 210. In general, the intake valve 212 may fluidly couple the intake manifold 112 to the cylinder 210 such that combustion air and/or fuel may be metered from the intake manifold 112 into the combustion cylinder 210.

Each combustion cylinder 210 may also include an exhaust valve 214 disposed between an exhaust system 216 and the cylinder 210. In general, the exhaust valve 214 may fluidly couple the cylinder 210 to the exhaust system 216 such that exhaust gases may be expelled out of the combustion cylinder 210.

Accordingly, evacuation of the intake manifold 112 and/or the engine 110 may require, in addition to closure of the electronic throttle body 150, the engine 110 to be stopped (i.e., de-activated, de-energized, etc.) such that at least one of the intake valve 212 and the exhaust valve 214 of each cylinder 210 is closed. If both the intake valve 212 and the exhaust valve 214 of a cylinder 210 are open such that the intake manifold 112 is fluidly coupled to the exhaust system 216, air may be pulled into the intake manifold 112 via the exhaust system 216.

In at least one embodiment, a crank shaft position sensor 160 (shown in FIG. 1) in electronic communication with the controller 110 may be implemented and configured to generate a crank shaft position signal indicative of the rotational position of the crank shaft, and therefore, the position of the intake 212 and exhaust 214 valves corresponding to each cylinder 210.

Accordingly, controller 140 may use the crank shaft position signal to control shut-down of the engine 110 such that at least one of the intake valve 212 and the exhaust valve 214 of each cylinder 210 is closed. However, it should be understood that any appropriate technique may be implemented to control shut-down of the engine 110 such that at least one of the intake valve 212 and the exhaust valve 214 of each cylinder 210 is closed.

FIG. 3 is a schematic diagram of a system 300 wherein the internal combustion engine 110 is coupled to a transmission of a hybrid electric vehicle 314. Further discussion of the hybrid electric vehicle transmission 314 is disclosed in commonly assigned U.S. patent application Ser. No. 10/248,886, filed Feb. 27, 2003, pending, hereby incorporated by reference in its entirety.

As previously discussed, noise, vibration and/or harshness may be particularly severe in a hybrid vehicle, such as a hybrid electric vehicle, during spin-up (i.e., hybrid start-up) of the engine 110 due to the high speed at which the engine 110 is spun. Accordingly, the present invention may be particularly beneficial when the engine 110 is coupled to a hybrid transmission, such as the transmission 314. While the transmission 314 illustrated in FIG. 3 has a parallel-series configuration, it should be understood that the present invention may be implemented in connection with any appropriate hybrid transmission and/or conventional transmission (e.g., 170) to meet the design criteria of a particular application.

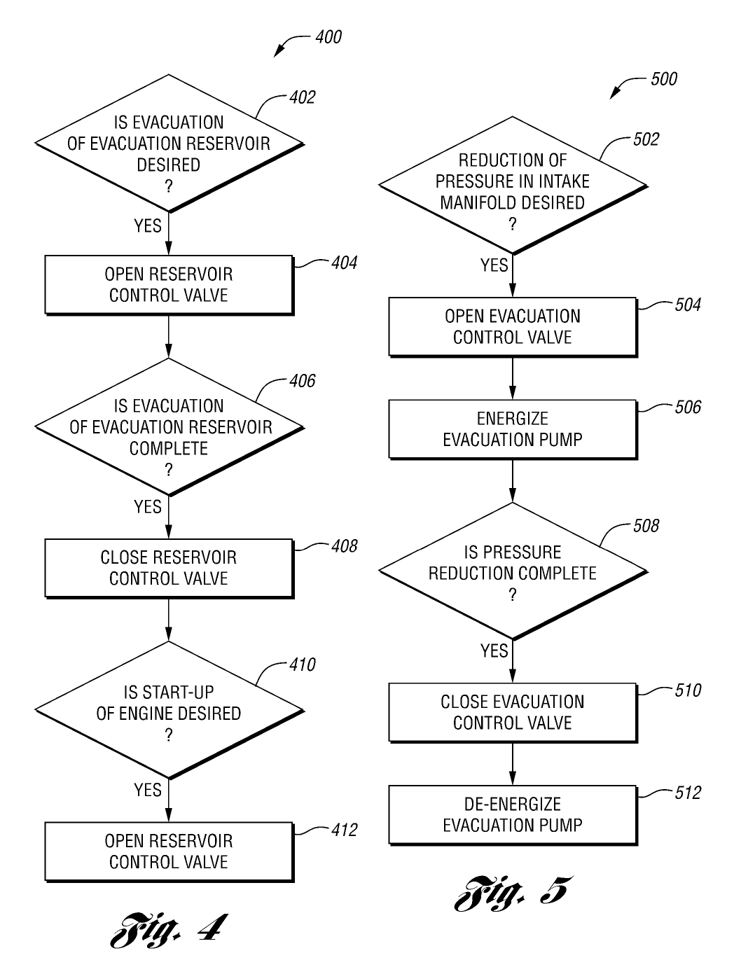

Referring to FIG. 4, a flow diagram of a method 400 for reducing pressure in an intake manifold (e.g., 112)of an internal combustion engine (e.g., 110) is shown. The method 400 may be advantageously implemented in connection with the system 100, described previously in connection with FIG. 1, the system 300, described previously in connection with FIG. 3, and/or any appropriate system/method to meet the design criteria of a particular application. In particular the method 400 is generally performed by a logical device, such as the controller 140. The method 400 generally includes a plurality of blocks or steps that may be performed serially. As will be appreciated by one of ordinary skill in the art, the order of the blocks/steps shown in FIG. 4 are exemplary and the order of one or more block/step may be modified within the spirit and scope of the present invention. Additionally, the blocks/steps of the method 400 may be performed in at least one non-serial (or non-sequential) order, and one or more blocks/steps may be omitted to meet the design criteria of a particular application. Similarly, two or more of the blocks/steps of the method 400 may be performed in parallel.

Decision block 402 generally determines when evacuation (i.e., a reduction in pressure) of an evacuation reservoir (e.g., 122) is desired. In at least one embodiment, decision block 402 may be satisfied (i.e., evacuation may be desired) when pressure in the intake manifold, as determined for example using a manifold pressure sensor (e.g., 114), is less than a predetermined intake manifold pressure threshold. In at least one other embodiment, decision block 402 may be satisfied when pressure in the intake manifold is less than pressure in the evacuation reservoir, as determined for example using a reservoir pressure sensor (e.g., 126). In yet at least one other embodiment, decision block 402 may be satisfied when the internal combustion engine has been operating (i.e., running) for a predetermined duration of time. In general, decision block 402 is not satisfied when the engine is not in operation as the operation of the engine generally provides the pressure differential used to evacuate the evacuation reservoir. However, decision block 402 may be satisfied in response to any appropriate stimulus (i.e., trigger) to meet the design criteria of a particular application. The method 400 generally falls through to step 404 when decision block 402 is satisfied.

At step 404, a reservoir control valve (e.g., 124) is generally opened to fluidly couple the evacuation reservoir to the intake manifold. The method 400 generally proceeds to decision block 406 from step 404.

Decision block 406 generally determines when evacuation of the evacuation reservoir is complete. In general, evacuation of the evacuation reservoir is complete when either the engine is de-energized, thereby eliminating the pressure differential required to evacuate the evacuation reservoir, and/or the pressure in the evacuation reservoir is less than or equal to a predetermined reservoir pressure threshold (i.e., desired evacuation reservoir pressure is obtained in the evacuation reservoir). However, decision block 406 may be satisfied in response to any appropriate stimulus (i.e., trigger) to meet the design criteria of a particular application. The method 400 generally falls through to step 408 when decision block 406 is satisfied.

At step 408, the reservoir control valve may be closed such that the relatively low pressure in the evacuation reservoir may be substantially maintained without regard to the operating mode of the engine and/or the pressure in the intake manifold. The method 400 generally proceeds to decision block 410 from step 408.

Decision block 410 generally determines when start-up (e.g., a subsequent start-up) of the engine is desired. In a conventional vehicle, start-up of the engine may be desired when an operator inserts and turns a corresponding ignition key. In a hybrid vehicle, start-up (i.e., spin-up) of the engine may be initiated by the controller 140 in response to an operator inserting and turning a corresponding ignition key, a request for additional vehicle power, and/or the like. However, decision block 410 may be satisfied in response to any appropriate stimulus (i.e., trigger) to meet the design criteria of a particular application. The method 400 generally falls through to step 412 when decision block 410 is satisfied.

At step 412, the reservoir control valve is generally opened to once again fluidly couple the evacuation reservoir to the intake manifold. In general, coupling the evacuation reservoir to the intake manifold allows the previously generated area of low pressure within the evacuation reservoir to pull gaseous fluids from the intake manifold, and therefore the engine, into the evacuation reservoir.

It should be understood that the method 400 is generally iterative such that an area of low pressure may be generated within the evacuation reservoir prior to each engine start-up. Accordingly, the method 400 provides for reducing pressure in an intake manifold (e.g., 112)of an internal combustion engine (e.g., 110).

Referring to FIG. 5, a flow diagram of a method 500 for reducing pressure in an intake manifold (e.g., 112)of an internal combustion engine (e.g., 110) is shown. The method 500 may be advantageously implemented in connection with the system 100, described previously in connection with FIG. 1, the system 300, described previously in connection with FIG. 3, the method 400, described previously in connection with FIG. 4, and/or any appropriate system/method to meet the design criteria of a particular application. In particular the method 500 is generally performed by a logical device, such as the controller 140. The method 500 generally includes a plurality of blocks or steps that may be performed serially. As will be appreciated by one of ordinary skill in the art, the order of the blocks/steps shown in FIG. 5 are exemplary and the order of one or more block/step may be modified within the spirit and scope of the present invention. Additionally, the blocks/steps of the method 500 may be performed in at least one non-serial (or non-sequential) order, and one or more blocks/steps may be omitted to meet the design criteria of a particular application. Similarly, two or more of the blocks/steps of the method 500 may be performed in parallel.

Decision block 502 generally determines when reduction of pressure in an intake manifold (e.g., 112), and therefore the engine (e.g., 110), is desired. In at least one embodiment, decision block 502 may be satisfied (i.e., reduction may be desired) when pressure in the intake manifold, as determined for example using a manifold pressure sensor (e.g., 114), is greater than a predetermined intake manifold pressure limit and/or the engine is de-activated, which may, in at least one embodiment, include a period of time during start-up of the engine 110 but prior to steady state operation of the engine 110. In at least one other embodiment, decision block 502 may be satisfied when start-up of the internal combustion engine is initiated. However, decision block 502 may be satisfied in response to any appropriate stimulus (i.e., trigger) to meet the design criteria of a particular application. The method 500 generally falls through to step 504 when decision block 502 is satisfied.

At step 504, an evacuation control valve (e.g., 138) is generally opened to fluidly couple an inlet port (e.g. 134) of an evacuation pump (e.g., 132) to the intake manifold. The method 500 generally proceeds to step 506 from step 504.

At step 506, the evacuation pump is generally energized to pull (i.e., remove) gaseous fluid out of the intake manifold, and therefore the engine, such that the pressure in the intake manifold is reduced. As previously discussed, steps 504 and 506 (i.e., the order in which the evacuation control valve is opened and the evacuation pump is energized) may be performed in any appropriate order and/or substantially simultaneously to meet the design criteria of a particular application. The method 500 generally proceeds to decision block 508 from step 506.

Decision block 508 generally determines when reduction of pressure in an intake manifold, and therefore the engine, is complete. In at least one embodiment, reduction of pressure in an intake manifold may be determined to be complete when the pressure in the intake manifold is less than or equal to the predetermined intake manifold pressure limit (i.e., desired intake manifold pressure is obtained in the intake manifold). In at least one other embodiment, reduction of pressure in an intake manifold may be determined to be complete when the evacuation pump has been energized for a predetermined period of time. However, decision block 508 may be satisfied in response to any appropriate stimulus (i.e., trigger) to meet the design criteria of a particular application. The method 500 generally falls through to step 510 when decision block 508 is satisfied.

At step 510, the evacuation control valve is generally closed to fluidly de-couple the inlet port of the evacuation pump from the intake manifold. The method 500 generally proceeds to step 512 from step 510.

At step 512, the evacuation pump is generally de-energized. As previously discussed, steps 510 and 512 (i.e., the order in which the evacuation control valve is closed and the evacuation pump is de-energized) may be performed in any appropriate order and/or substantially simultaneously to meet the design criteria of a particular application.

In accordance with various embodiments of the present invention, the methods described herein may be implemented as programs running on a processor, such as a computer processor. Dedicated hardware implementations including, but not limited to, application specific integrated circuits, programmable logic arrays and other hardware devices can likewise be constructed to implement the methods described herein.

It should also be noted that the program implementations of the present invention as described herein are optionally stored on a tangible storage medium, such as a magnetic medium, a magneto-optical or optical medium, or a solid state medium.

As previously discussed, one or more system (e.g., 100, 300) and/or method (e.g., 400, 500) of the present invention may provide one or more benefits such as a reduction and/or elimination of undesirable noise, vibration, harshness and/or emissions during start-up of an engine (e.g., 110) in a conventional and/or hybrid vehicle (e.g., automobile).

In particular, noise, vibration and/or harshness generated by the compression of un-combusted air during start-up/spin-up of an internal combustion engine may be reduced by the evacuation of the un-combustible air from the intake manifold.

Furthermore, Hydrocarbon emissions emitted during initial start-up of an internal combustion engine may be reduced by the evacuation of air from the intake manifold. In at least one embodiment, evacuation of air from the intake manifold may reduce oxygen loading of the exhaust catalyst. In at least one other embodiment, evacuation of the air may reduce the amount of fuel injected during the initial combustion events of start-up. By limiting the amount of fuel injected into the engine during start-up, the resulting level of emissions passing unconverted through the relatively cold emissions system catalyst may be reduced.

While the best mode for carrying out the invention has been described in detail, those familiar with the art to which this invention relates will recognize various alternative designs and embodiments for practicing the invention as defined by the following claims.

What is claimed:

1. A pressure reducing system for an internal combustion engine, the system comprising:
an intake manifold associated with the internal combustion engine; and
an evacuation subsystem selectively fluidly coupled to the intake manifold, the evacuation subsystem being operative to reduce pressure in the intake manifold during start-up of the internal combustion engine.

2. The system of claim 1 further comprising:
a controller associated with the internal combustion engine;
wherein the evacuation subsystem further comprises an evacuation reservoir and a reservoir control valve that selectively fluidly couples the evacuation reservoir to the intake manifold, the reservoir control valve being in electronic communication with the controller;
wherein the reservoir control valve is opened when the internal combustion engine is operating such that pressure in the evacuation reservoir is reduced; and
wherein the reservoir control valve is opened during a subsequent start-up of the internal combustion engine such that the pressure in the intake manifold is reduced.

3. The system of claim 2 further comprising:
a manifold pressure sensor in electronic communication with the controller and configured to generate a manifold pressure signal indicative of the pressure in the intake manifold;
wherein the reservoir control valve is opened when the internal combustion engine is operating and the manifold pressure signal indicates that the pressure in the intake manifold is below a predetermined intake manifold pressure threshold, such that the pressure in the evacuation reservoir is reduced.

4. The system of claim 3 further comprising a reservoir pressure sensor in electronic communication with the controller and configured to generate a reservoir pressure signal indicative of the pressure in the evacuation reservoir.

5. The system of claim 4 wherein the predetermined intake manifold pressure threshold is based at least in part on the reservoir pressure signal.

6. The system of claim 4 wherein the reservoir control valve is closed when the reservoir pressure signal indicates that the pressure in the evacuation reservoir is less than a predetermined reservoir pressure threshold or the internal combustion engine is shut-down.

7. The system of claim 1 wherein the evacuation subsystem further comprises:
an evacuation pump having an inlet port and an outlet port; and
an evacuation control valve disposed between and fluidly coupled to the intake manifold and the inlet port.

8. The system of claim 7 further comprising a controller associated with the internal combustion engine;
wherein the evacuation pump and the evacuation control valve are in electronic communication with the controller; and
wherein the evacuation pump is energized and the evacuation control valve is opened via one or more evacuation control signals generated by the controller.

9. The system of claim 8 wherein the one or more evacuation control signals are selectively generated by the controller when the internal combustion engine is de-activated.

10. The system of claim 8 further comprising a manifold pressure sensor in electronic communication with the controller and configured to generate a manifold pressure signal indicative of a pressure in the intake manifold, wherein the one or more evacuation control signals are generated by the controller when the internal combustion engine is de-activated and the manifold pressure signal indicates that the pressure in the intake manifold is above a predetermined intake manifold pressure limit.

11. The system of claim 8 wherein the evacuation control valve is closed when the evacuation pump is de-energized to inhibit backflow of gaseous fluids from the evacuation pump into the intake manifold.

12. The system of claim 7 further comprising an electronic throttle body fluidly coupled to an inlet of the intake manifold and a hydrocarbon trap fluidly coupled to an inlet of the electronic throttle body via a conduit, wherein the outlet port of the evacuation pump is fluidly coupled to the conduit between the electronic throttle body and the hydrocarbon trap.

13. The system of claim 1 wherein the internal combustion engine is coupled to a hybrid vehicle and start-up of the internal combustion engine corresponds to spin-up of the internal combustion engine during operation of the hybrid vehicle.

14. A method for reducing pressure in an intake manifold of an internal combustion engine, the method comprising:
opening a reservoir control valve to fluidly couple an evacuation reservoir to the intake manifold when the internal combustion engine is operating and a predetermined condition is satisfied;
determining when a subsequent start-up of the internal combustion engine is desired; and
opening the reservoir control valve to fluidly couple the evacuation reservoir to the intake manifold during the subsequent start-up of the internal combustion engine.

15. The method of claim 14 further comprising determining pressure in the intake manifold, wherein the predetermined condition is satisfied when the pressure in the intake manifold is less than pressure in the evacuation reservoir.

16. The method of claim 14 further comprising determining pressure in the intake manifold, wherein the predetermined condition is satisfied when the pressure in the intake manifold is less than a predetermined intake manifold pressure threshold.

17. The method of claim 14 wherein the predetermined condition is satisfied when the internal combustion engine has been operating for a predetermined duration of time.

18. A method for reducing pressure in an intake manifold of an internal combustion engine, the method comprising:
determining when reduction of the pressure in the intake manifold is desired;
opening an evacuation control valve to fluidly couple an inlet port of an evacuation pump to the intake manifold when reduction of the pressure in the intake manifold is desired; and
energizing the evacuation pump to remove gaseous fluid from the intake manifold such that the pressure in the intake manifold is reduced.

19. The method of claim 18 further comprising determining the pressure in the intake manifold, wherein reduction of the pressure in the intake manifold is desired when the internal combustion engine is de-activated and the pressure in the intake manifold is greater than a predetermined intake manifold pressure limit.

20. The method of claim 18 wherein reduction of the pressure in the intake manifold is desired when start-up of the internal combustion engine is initiated.
